(19) United States
(12) Patent Application Publication
(10) Pub. No.: US 2011/0101772 A1
(43) Pub. Date: May 5, 2011

(54) CONTROL VALVE FOR A VEHICLE BRAKE SYSTEM, AND VEHICLE BRAKE SYSEM HAVING SUCH A CONTROL VALVE

(76) Inventors: Rene Schepp, Waiblingen (DE); Norbert Alaze, Markgroeningen (DE)

(21) Appl. No.: 12/737,202

(22) PCT Filed: Apr. 20, 2009
(86) PCT No.: PCT/EP2009/054648

§ 371 Date: Jan. 14, 2011

(30) Foreign Application Priority Data
Jun. 19, 2008 (DE) 102008002539.9

(51) Int. Cl. B60T 8/34; B60T 13/16; F15B 7/10; F15B 7/00

(52) U.S. Cl. 303/10; 303/116.1; 60/592; 60/591

(57) ABSTRACT

The invention relates to a control valve for a vehicle brake system having a first fluid connection, a second fluid connection, and a decompressed connection toward the atmosphere. An adjustment spring applies a spring force to a control piston moving in longitudinal direction on the decompressed side, the control piston completely releasing a fluid connection between the first fluid connection and the second fluid connection in an initial position, and to a corresponding vehicle brake system having such a control valve. According to the invention the control valve includes a valve body having a seal seat and a sealing element coupled to a control piston. A sealing region of the sealing element interacts with the seal seat of the valve body in order to limit an effective pressure present on the second fluid connection to a predetermined maximum pressure value. The effective diameter of the control piston is greater than or equal to an effective diameter of the sealing element.

### PRIOR ART

The invention is based on a control valve for a vehicle brake system as generically defined by the preamble to independent claim 1.

From the prior art, vehicle brake systems are known which include various safety systems, such as an anti-lock system (ABS), an electronic stability program (ESP), and so forth, and which perform various safety functions, such as an anti-lock function, traction control (TC), and so forth. FIG. 1 shows a vehicle brake system with which various safety functions can be performed.

As can be seen from FIG. 1, a conventional vehicle brake system 1 has a master cylinder 2, a fluid control unit 3, indicated by dot-dashed lines, and four wheel brakes 4.1 through 4.4, which each have an associated wheel brake cylinder, not shown. Each two of the four wheel brakes 4.1 through 4.4 are assigned to one brake circuit 10, 20, and each brake circuit 10, 20 communicates with the master cylinder 2. Thus a first wheel brake 4.1, which is disposed for instance on a rear vehicle axle on the left, and a second wheel brake 4.2, which is for instance disposed on a front vehicle axle on the right, are assigned to a first brake circuit 10, and a third wheel brake 4.3, which is disposed for instance on a front vehicle axle on the right, and a fourth wheel brake 4.4, which is disposed for instance on a rear vehicle axle on the left, are assigned to a second brake circuit 20. One inlet valve 13.1, 13.2, 23.1, 23.2 and one outlet valve 14.1, 14.2, 24.1, 24.2 are assigned to each wheel brake 4.1 through 4.4, and via the inlet valves 13.1, 13.2, 23.1, 23.2, pressure in the corresponding wheel brake 4.1 through 4.4 can be built up, and via the outlet valves 14.1, 14.2, 24.1, 24.2, pressure in the corresponding wheel brake 4.1 through 4.4 can be reduced.

As can also be seen from FIG. 1, the first brake circuit 10 has a first intake valve 11, a first switchover valve 12, a first fluid reservoir 16, and a first return pump 15. The second brake circuit 20 has a second intake valve 21, a second switchover valve 22, a second fluid reservoir 26, and a second return pump 25, and in the example shown, the first and second return pumps 15, 25 are driven by the same electric motor 35. The fluid control unit 3 also includes a sensor unit 30, for ascertaining the actual brake pressure. The fluid control unit 3 uses the first switchover valve 12, the first intake valve 11, and the first return pump 15 for modulating the brake pressure in the first brake circuit 10, and it uses the second switchover valve 22, the second intake valve 21, and the second return pump 25 for modulating the brake pressure in the second brake circuit 20.

The return pumps 15, 25 of the two brake circuits 10, 20 can be embodied as piston pumps or geared pumps, for example. During an ESP control operation, a brake pressure of up to 140 bar can be established through the open intake valves 11 and 21, respectively, and the intake side of the corresponding return pump 15, 25 is acted upon by that pressure when braking is necessary in the system. Even in a partly active system state, the return pumps 15, 25 can be acted upon on the intake side by up to 140 bar. Moreover, a pilot pressure can occur on the intake side of the return pumps 15, 25 if the pressure of the master cylinder 2 is carried via the open switchover valves 12 and 22 to the respective return pumps 15, 25 and is then reinforced up to the wheel pressure required for the regulation via the corresponding return pump 15 and 25, respectively. In a version of the return pumps 15, 25 as piston pumps, this high pressure, which acts on a seal on the eccentric side of the return pumps 15, 25, can lead to very high wear, extrusion, and resultant increased leakage. If a geared pump is used as the return pump 15, 25, then this high pressure puts stress on the wave sealing rings of the return pumps 15, 25, which can lead to increased friction and, as with the piston pump, to increased wear of the seals, and wave sealing rings that withstand high pressure are very expensive.

As can also be seen from FIG. 1, for limiting the effective pressure on the intake side of the corresponding return pump 15, 25, one additional control valve 40, 40′ is looped into a respective suction line between the corresponding return pumps 15, 25 and the master cylinder 2, as described in a patent application, not published by the priority dale of the present application, of the present Applicant (Internal Docket No.: R. 318993), so that the corresponding return pump 15, 25 communicates on the intake side with the master cylinder 2 via the control valve 40, 40′ or the intake valve 11, 21; that is, the control valve 40, 40′ is connected parallel to the intake valve 11, 21 and limits the effective pressure on the intake side of the return pump 15 to the predeterminable maximum pressure value.

As can be seen from FIGS. 2 and 3, the control valve 40, 40′ has a master cylinder connection 41, 41′, a pipe connection 42, 42′, a pressure-relieved connection 43, 43′ to the atmosphere, and a longitudinally movable piston 44. The longitudinally movable piston 44 is embodied as a stepped piston 44, which toward the pressure-relieved connection 43, 43′ has a first diameter 48.1 and toward the pipe connection 42, 42′ has a second diameter 48.2; the second diameter 48.2 is embodied as greater than the first diameter 48.1. The piston 44 is sealed off from the housing toward the pressure-relieved connection 43, 43′ and toward the pipe connection 42, 42′ via a respective sealing ring 46.1, 46.2. A transition of the piston 44 from the first to the second diameter 48.1, 48.2 is embodied as a sealing cone 49.1, which corresponds with a seal seat 49.2 in the housing. The longitudinally movable piston 44 is subjected to a spring force by an adjusting spring 45 on the pressure-relieved side and remains in a pressureless state, in an outset position that is shown in FIG. 2, in which a fluid communication, existing via a piston bore 44.1, between the master cylinder connection 41 and the pipe connection 42 is fully open. During an ABS intervention, the piston 44 is subjected by the master cylinder connection 41 to a pressure which moves the piston 44 in the direction of the pressure-relieved connection 43′, counter to the spring force of the adjusting spring 45. Upon attainment of the maximum pressure value and the corresponding stop position, which is shown in FIG. 3, the sealing cone 49.1 of the piston 44 provides sealing in the seal seat 49.2 of the housing, and the communication between the master cylinder connection 41′ and the pipe connection 42′ is completely interrupted by the piston 44. As a result, the inflow from the master cylinder 2 to the return pump 25 is prevented, and in this state the fluid control unit 3 can perform an ABS control operation.

During a partly active state of the brake system, the piston 44 of the control valve 40, 40′ is acted upon by the master cylinder connection 41, 41′ by a pressure which moves the piston 44 in the direction of the pressure-relieved connection 43, 43′, counter to the spring force of the adjusting spring 45, and the fluid communication between the master cylinder connection 41, 41′ and the pipe connection 42, 42′ is reduced by means of the piston motion. Upon attainment of the maximum pressure value, the piston 44 is located in the corresponding stop position, which is shown in FIG. 3, and in which the communication between the master cylinder connection 41′ and the pipe connection 42′ is completely interrupted by the piston 44. As a result, a further pressure buildup to the return pump 25 is prevented. If the actual pressure in the control valve 40′ drops below the maximum pressure value, then the spring force of the adjusting spring 45 moves the piston 44 out of the stop position in the direction of the outset position, as a result of which the communication between the master cylinder connection 41, 41′ and the pipe connection 42, 42′ is opened again. It is thus ensured that the pressure in the line to the master cylinder 2 can build up, without causing the pressure in the intake side of the return pump 15, 25 to rise above the predetermined maximum pressure value. In FIG. 3, reference numeral 47 indicates the maximum stroke of the piston 44. During an ESP intervention, the piston 44 of the control valve 40 remains in the outset position, and in this state, the return pump 15 aspirates fluid in parallel via the control valve 40 and the intake valve 11.

In the control valve 40, 40′ described in the patent application, not published by the priority date of the present application, of the present Applicant (Internal Docket No.: R. 318993), the diameter 48.1 of the piston 44, which piston is moved in the closing direction by way of the applied control pressure, counter to the return pump 45, is less than the diameter 48.2 of the seal seat 49.1 that receives the sealing cone 49.2. The control pressure for actuating the control valve 40, 40′ should therefore be relatively high, and the friction of the sealing elements can lead to increased hysteresis of the closing pressure.

### DISCLOSURE OF THE INVENTION

The control valve of the invention for a vehicle brake system, having the characteristics of independent claim 1, has the advantage over the prior art that it has a valve body with a seal seat and also has a sealing element coupled with a control piston. A sealing region of the sealing element cooperates with the seal seat of the valve body in order to limit an effective pressure at the second fluid connection to a predeterminable maximum pressure value, and an effective diameter of the control piston is embodied as greater than or equal to an effective diameter of the sealing element, in order to improve the control quality of the control valve and to lessen a required control pressure for actuating the control valve. The control valve of the invention has a first fluid connection, a second fluid connection, and a pressure-relieved connection to the atmosphere, in which a longitudinally movable control piston is acted upon on the pressure-relieved side with a spring force by an adjusting spring and in an outset position fully opens a fluid communication between the first fluid connection and the second fluid connection. The control valve of the invention can advantageously take on the function of an intake valve in the vehicle brake system and can additionally protect a return pump against elevated pilot pressure on the intake side.

By the provisions and refinements recited in the dependent claims, advantageous improvements to the control valve for a vehicle brake system, as defined in independent claim 1, are possible.

It is especially advantageous that the control piston is coupled by a pin to the sealing element, and the control piston and the sealing element are disposed on different sides of the valve body, and the pin is guided by a flow opening of the valve body. The sealing element can for instance be slipped onto the pin and is sealed off at the rear region via a sealing lip on the pin. Furthermore, the sealing element, on the front region, can have a radial motion clearance relative to the pin. As a result, production tolerances can advantageously be compensated for, and secure closure of the valve can be ensured.

In a further feature of the control valve of the invention, the pin is connected on one end to the control piston, which is sealed off via a first seal from a first valve wall and on the other end has a collar, on which a second seal rests, which is axially prestressed via a spring element braced on the sealing element and seals off the pin from a second valve wall. The seal at the pin should be as low-friction as possible, to prevent excessive hysteresis. This is achieved by the axial prestressing of the second seal by the spring element. Thus radial prestressing of the seal, which could lead to fundamental friction in the pressureless state, can advantageously be avoided. Moreover, when a higher pressure is applied, the seal can seal with pressure reinforcement.

In a further feature of the control valve of the invention, a pressure building up at the first fluid connection moves the control piston, counter to the spring force of the adjusting spring, in the direction of the pressure-relieved connection, and the fluid communication between the first fluid connection and the second fluid connection can advantageously be reduced. At the predetermined maximum pressure value at the second fluid connection, the fluid communication between the first fluid connection and the second fluid connection is completely interrupted by a stop position of the sealing region of the sealing element in the seal seat of the valve body, and the spring force of the adjusting spring moves the control piston back out of the stop position in the direction of the outset position when the actual pressure at the second fluid connection drops below the maximum pressure value.

In a further feature of the control valve of the invention, the first fluid connection is for instance embodied as a master cylinder connection, which is coupled with a master cylinder in the vehicle brake system, and the second fluid connection is for instance embodied as a pipe connection, which is coupled with a return pump.

A vehicle brake system of the invention having the characteristics of independent claim 8 includes a master cylinder, a fluid control unit, and at least one wheel brake, in which the fluid control unit, for modulating the brake pressure of the at least one wheel brake in at least one brake circuit, includes one switchover, one intake valve, and one return pump each. The intake valve of the at least one brake circuit is advantageously embodied as a control valve of the invention as described above, which is looped into a respective section line between the corresponding return pump and the master cylinder. Thus the control valve of the invention in the vehicle brake system advantageously takes on the function of the intake valve and protects the return pump against elevated pilot pressure on the intake side. As a result of the limitation to the effective pressure on the intake side of the return pump, wear, friction, and extrusion of the seals in the return pump can be reduced, and as a result, advantageously, leakage from the return pump to the outside can also be reduced, the efficiency can be increased, and the service life of the return pump can be lengthened markedly. In a return pump embodied as a geared pump, an expensive, complex wave seal ring that withstands high pressure is avoided as well, and an inexpensive wave seal can be installed.

By the provisions and refinements recited in the dependent claims, advantageous improvements to the vehicle brake system as defined in independent claim 8 are possible.

It is especially advantageous that the control piston of the control valve, during a suction mode of the return pump, remains in the outset position, and during a partly active state of the brake system it is subjected by the master cylinder connection to a pressure which moves the control piston in the direction of the pressure-relieved connection, counter to the spring force of the adjusting spring. Upon attainment of the maximum pressure value and the corresponding stop position, in which the sealing region of the sealing element, coupled with the control piston, provides sealing in the seal seat of the valve body, the piston completely interrupts the fluid communication between the master cylinder connection and the pipe connection. The spring force of the adjusting spring moves the control piston out of the stop position in the direction of the outset position when the actual pressure at the pipe connection drops below the maximum pressure value.

In a feature of the vehicle brake system of the invention, the control piston of the control valve, in the pressureless state, remains in the outset position, and during an ABS intervention is acted upon by the master cylinder connection with a pressure which moves the control piston, counter to the spring force of the adjusting spring, in the direction of the pressure-relieved connection. Upon attainment of the maximum pressure value and the corresponding stop position, in which the sealing region of the sealing element, coupled with the control piston, provides sealing in the seal seat of the valve body, the control piston completely interrupts the fluid communication between the master cylinder connection and the pipe connection, and in this state the fluid control unit performs an ABS control operation.

Exemplary embodiments of the invention are shown in the drawings and will be described in further detail in the ensuing description.

### BRIEF DESCRIPTION OF THE DRAWINGS

FIG. 1 shows a schematic block diagram of a conventional vehicle brake system.

FIGS. 2 and 3 each show a schematic sectional view of a control valve for the vehicle brake system of FIG. 1.

FIG. 4 shows a schematic block diagram of an exemplary embodiment of a vehicle brake system of the invention.

FIGS. 5 and 6 each show a schematic sectional view of an exemplary embodiment of a control valve of the invention for the vehicle brake system of FIG. 4.

### EMBODIMENTS OF THE INVENTION

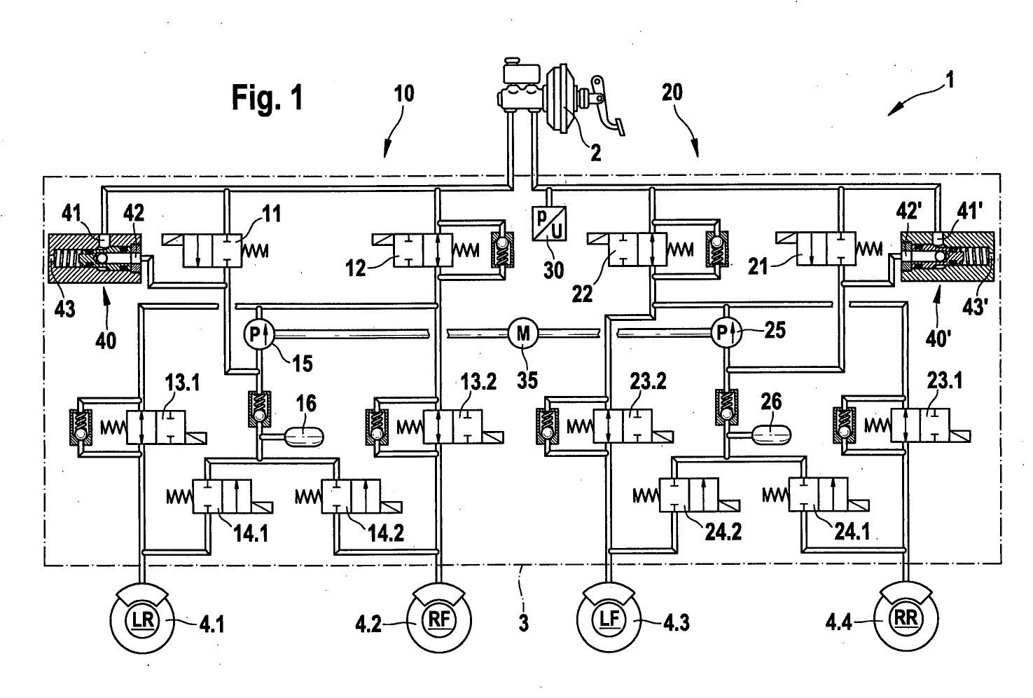

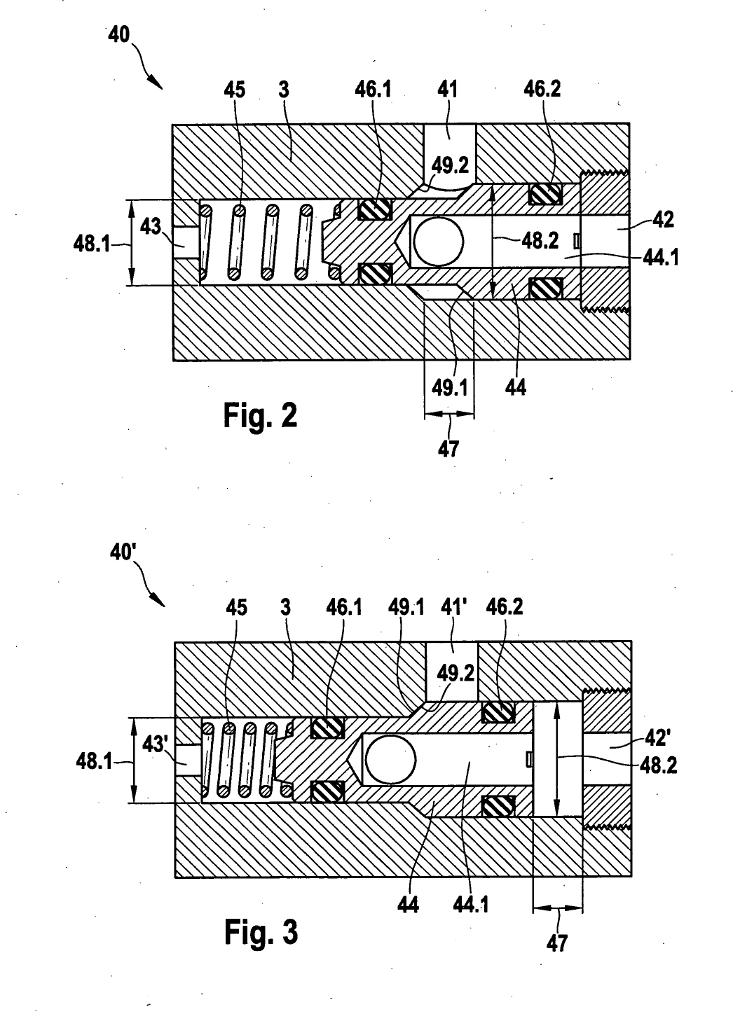

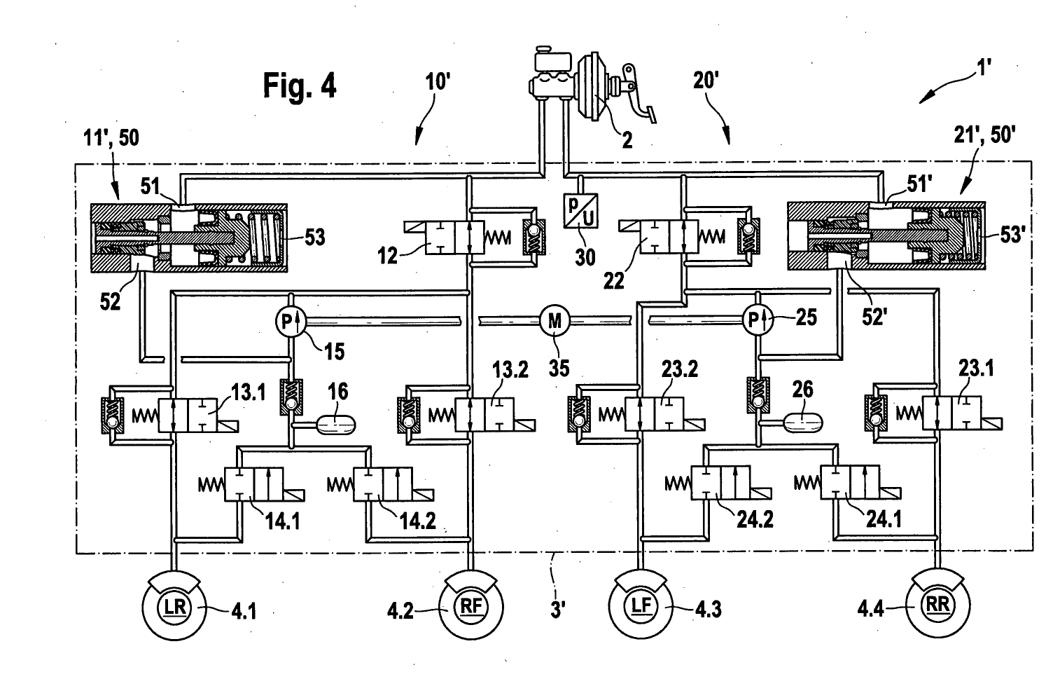

The exemplary embodiment, shown in FIG. 4, of a vehicle brake system 1′ of the invention is constructed essentially identically to the conventional vehicle brake system 1 of FIG. 1, and it includes the same components, which perform the same or analogous functions, with the addition of a first control valve 50 and a second control valve 50′. Thus the exemplary embodiment of the vehicle brake system 1′ of the invention includes a master cylinder 2, a fluid control unit 3′, indicated by dot-dashed lines, and four wheel brakes 4.1 through 4.4, which each have an associated wheel brake cylinder, not shown. Each two of the four wheel brakes 4.1 through 4.4 are assigned to one brake circuit 10′, 20′, and each brake circuit 10′, 20′ communicates with the master cylinder 2. Thus a first wheel brake 4.1, which is disposed for instance on a rear vehicle axle on the left, and a second wheel brake 4.2, which is for instance disposed on a front vehicle axle on the right, are assigned to a first brake circuit 10′, and a third wheel brake 4.3, which is disposed for instance on a front vehicle axle on the right, and a fourth wheel brake 4.4, which is disposed for instance on a rear vehicle axle on the left, are assigned to a second brake circuit 20′. One inlet valve 13.1, 13.2, 23.1, 23.2 and one outlet valve 14.1, 14.2, 24.1, 24.2 are assigned to each wheel brake 4.1 through 4.4, and via the inlet valves 13.1, 13.2, 23.1, 23.2, pressure in the corresponding wheel brake 4.1 through 4.4 can be built up, and via the outlet valves 14.1, 14.2, 24.1, 24.2, pressure in the corresponding wheel brake 4.1 through 4.4 can be reduced.

As can also be seen from FIG. 4, a first inlet valve 13.1 and a first outlet valve 14.1 are assigned to the first wheel brake 4.1; a second inlet valve 13.2 and a second outlet valve 14.2 are assigned to the second wheel brake 4.2; a third inlet valve 23.1 and a third outlet valve 24.2 are assigned to the third wheel brake 4.3; and a fourth inlet valve 23.1 and a fourth outlet valve 24.1 are assigned to the fourth wheel brake 4.4. Moreover, the first brake circuit 10′ has a first intake valve 11′, a first switchover valve 12, a first fluid reservoir 16, and a first return pump 15. The second brake circuit 20′ has a second intake valve 21′, a second switchover valve 22, a second fluid reservoir 26. The return pumps 15, of the two brake circuits 10′, 20′ can be embodied for instance as piston pumps or geared pumps and in the exemplary embodiment shown are driven by the same electric motor 35. Furthermore, the fluid control unit 3′ includes a sensor unit 30, for ascertaining the actual brake pressure. The fluid control unit 3′ uses the first switchover valve 12, the first intake valve 11′, and the first return pump 15 for modulating the brake pressure in the first brake circuit 10′, and it uses the second switchover valve 22, the second intake valve 21′, and the second return pump 25 for modulating the brake pressure in the second brake circuit 20′.

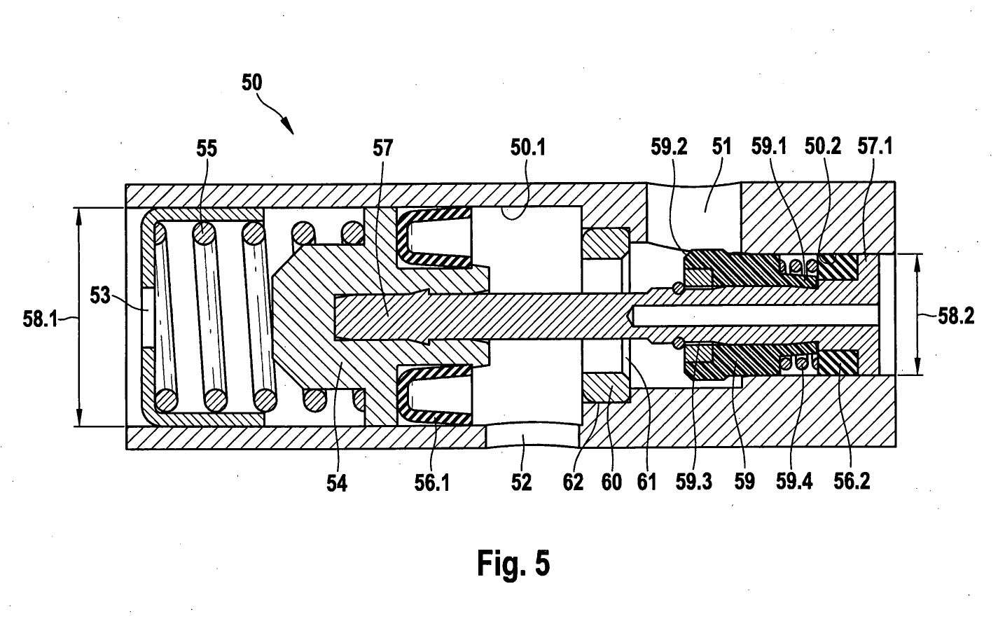

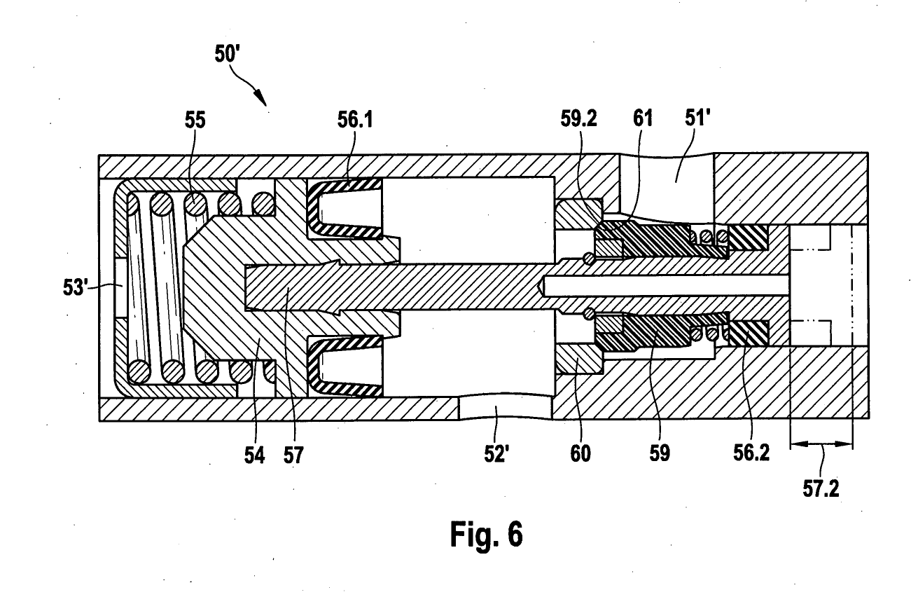

According to the invention, the intake valves 11′, 21′ are embodied as control valves 50, 50′, which are each looped in a respective suction line between the corresponding return pumps 15, 25 and the master cylinder 2. The control valves 50, 50′ will be described below in conjunction with FIGS. 5 and 6. In the exemplary embodiment shown, the first control valve 50 is shown in the open state in FIGS. 4 and 5, during an intake mode of the first return pump 15, and the second control valve 50′ is shown in FIGS. 4 and 6 in the closed state.

As can be seen from FIGS. 5 and 6, the control valves 50, 50′ each have a master cylinder connection 51, 51′, a pipe connection 52, 52′, and a pressure-relieved connection 53, 53′ to the atmosphere. In addition, the control valves 50, 50′ each have one valve body 60 with a seal seat 61 and one sealing element 59 coupled with a control piston 54. A sealing region 59.2 of the sealing element 59 cooperates with the seal seat 61 of the valve body 60, in order to limit an effective pressure at the pipe connection 52, 52′ to a predeterminable maximum pressure value. In the exemplary embodiment shown, the valve body 60 is calked tightly to a valve wall in a calked region 62, and an effective diameter 58.1 of the control piston 54 is embodied as greater than an effective diameter 58.2 of the sealing element 59. This advantageously makes it possible to improve the control quality and to reduce the control pressure for actuating the control valve. The longitudinally movable control piston 54 is subjected to a spring force from an adjusting spring 55 on the pressure-relieved side, and in the outset position shown in FIG. 5, it fully opens a fluid communication between the master cylinder connection 51 and the pipe connection 52.

As can also be seen from FIGS. 5 and 6, the control piston 54 is coupled by a pin 57 to the sealing element 59, and the control piston 54 and the sealing element 59 are disposed on different sides of the valve body 60; that is, in the exemplary embodiment shown, the control piston 54 is disposed on the left of the valve body 60, and the sealing element 59, in the exemplary embodiment shown, is disposed on the right of the valve body 60. For coupling the control piston 54 to the sealing element 59, the pin 57 is passed through a flow opening in the valve body 60. The sealing element 59 is slipped onto the pin 57 and is sealed off in the rear region via a sealing lip 59.1, made for instance from plastic, on the pin 57. In the front region, the sealing element 59 has a radial motion clearance 59.3 relative to the pin 57, to compensate for production tolerances and to ensure secure closure of the control valve. In the exemplary embodiment shown, the pin 57 is latched on one end via pawls in a blind bore in the control piston 54 and is thus solidly connected to the control piston 54, which is sealed off from a first valve wall 50.1 via a first sealing ring 56.1. Alternatively, the pin 57 can be press-fitted on one end into the blind bore in the control piston 54 and thus solidly joined to the control piston 54. On the other end, the pin 57 has a collar 57.1, on which a second sealing ring 56.2 rests, and this sealing ring, via a spring element 59.4 braced on the sealing element 59, is axially prestressed and seals off the pin 57 from a second valve wall 50.2.

During an ABS intervention, the first diameter 58.1 of the control piston 54 is acted upon by the master cylinder 51, 51′ with a pressure of approximately 2 bar, which moves the control piston 54 in the direction of the pressure-relieved connection 53, 53′ counter to the spring force of the adjusting spring 55, and in the process, via the pin 57, pulls the sealing element 59 with the second diameter 58.2 along with it until the sealing region 59.2, embodied as a sealing cone, of the sealing element 59 rests on the seal seat 61 of the valve body 60, in a stop position shown in FIG. 6. Upon attainment of the maximum pressure value of approximately 2 bar and of the corresponding stop position, which is shown in FIG. 6, the sealing region 59.2, embodied as a sealing cone, of the sealing element 59 provides sealing at the seal seat 61 of the valve body 60, and the fluid communication between the master cylinder connection 51′ and the pipe connection 52′ is interrupted completely, and in this state the fluid control unit 3′ performs an ABS control operation. Since the diameter of the sealing region 59.2 and the diameter of the seal seat 61 can be designed to be equal, after the closure of the control valve 50, 50′ a higher pressure of the master cylinder 2 is maintained, without the high pressure reaching as far as the inlet to the return pump 25.

During a partly active state of the vehicle brake system 1′, the piston 54 of the control valve 50 is acted upon by the master cylinder connection 51 with a pressure which moves the piston 54 in the direction of the pressure-relieved connection 53, counter to the spring force of the adjusting spring 55, whereupon the fluid communication between the master cylinder connection 51 and the pipe connection 52 is reduced as a result of the corresponding motion of the sealing element 59. Upon attainment of the maximum pressure value, the piston 54 is located in the corresponding stop position, which is shown in FIG. 6, and in which the communication between the master cylinder connection 51′ and the pipe connection 52′ is completely interrupted by the sealing element 59. It is thus ensured that the pressure in the line to the master cylinder 2 can build up, without causing the pressure in the intake side of the return pump 25 to rise above the predetermined maximum pressure value. If the actual pressure at the pipe connection 52′ is reduced, for instance because the return pump 25 is aspirating, then the spring force of the adjusting spring 55 moves the piston 54 out of the stop position in the direction of the outset position, and as a result the communication between the master cylinder connection 51, 51′ and the pipe connection 52, 52′ is reopened, until the pressure of approximately 2 bar is reached as a result of an actuation of the master cylinder 2. Thus the return pump 15, 25 always has a pilot pressure, yet it remains protected against the high pressure of the master cylinder 2. In the ESP situation, the control valve 50 remains open, and the brake fluid can be aspirated by the return pump 15, unhindered. In FIG. 6, reference numeral 57.2 indicates the maximum stroke of the sealing element 59.

Because the diameter of the control piston can be embodied as greater than or equal to the diameter of the sealing element, the control valve of the invention makes it possible to improve the control quality and to reduce the control pressure for actuating the control valve. In addition, the control valve of the invention can take on the task of the intake valve in the vehicle brake system and can additionally protect the return pump against elevated pilot pressure on the intake side.

1-10. (canceled)

11. A control valve for a vehicle brake system, having a first fluid connection, a second fluid connection, and a pressure-relieved connection to the atmosphere, in which a longitudinally movable control piston is acted upon on the pressure-relieved side with a spring force by an adjusting spring and in an outset position fully opens a fluid communication between the first fluid connection and the second fluid connection, further having a valve body with a seal seat and a sealing element coupled with the control piston, a sealing region of the sealing element cooperating with the seal seat of the valve body in order to limit an effective pressure at the second fluid connection to a predetermined maximum pressure value, wherein an effective diameter of the control piston is embodied as greater than or equal to an effective diameter of the sealing element.

12. The control valve as defined by claim 11, wherein the control piston is coupled by a pin to the sealing element and the control piston and the sealing element are disposed on different sides of the valve body, and the pin is guided by a flow opening of the valve body.

13. The control valve as defined by claim 12, wherein the sealing element is slipped onto the pin and is sealed off at a rear region thereof via a sealing lip on the pin.

14. The control valve as defined by claim 12, wherein the sealing element, on a front region thereof, has a radial motion clearance relative to the pin.

15. The control valve as defined by claim 13, wherein the sealing element, on a front region thereof, has a radial motion clearance relative to the pin.

16. The control valve as defined by claim 12, wherein the pin is connected on one end to the control piston, which is sealed off via a first seal from a first valve wall and on an other end thereof has a collar, on which a second seal rests, which is axially prestressed via a spring element braced on the sealing element and seals off the pin from a second valve wall.

17. The control valve as defined by claim 13, wherein the pin is connected on one end to the control piston, which is sealed off via a first seal from a first valve wall and on an other end thereof has a collar, on which a second seal rests, which is axially prestressed via a spring element braced on the sealing element and seals off the pin from a second valve wall.

18. The control valve as defined by claim 14, wherein the pin is connected on one end to the control piston, which is sealed off via a first seal from a first valve wall and on an other end thereof has a collar, on which a second seal rests, which is axially prestressed via a spring element braced on the sealing element and seals off the pin from a second valve wall.

19. The control valve as defined by claim 15, wherein the pin is connected on one end to the control piston, which is sealed off via a first seal from a first valve wall and on an other end thereof has a collar, on which a second seal rests, which is axially prestressed via a spring element braced on the sealing element and seals off the pin from a second valve wall.

20. The control valve as defined by claim 12, wherein a pressure building up at the first fluid connection moves the control piston, counter to the spring force of the adjusting spring, in the direction of the pressure-relieved connection, and the fluid communication between the first fluid connection and the second fluid connection is reducible by a motion of the sealing element coupled with the control piston, and the fluid communication between the first fluid connection and the second fluid connection, at the predetermined maximum pressure value at the second fluid connection, is completely interrupted by a stop position of the sealing region of the sealing element in the seal seat of the valve body, and the spring force of the adjusting spring moves the control piston back out of the stop position toward the outset position when an actual pressure at the second fluid connection drops below the maximum pressure value.

21. The control valve as defined by claim 13, wherein a pressure building up at the first fluid connection moves the control piston, counter to the spring force of the adjusting spring, in the direction of the pressure-relieved connection, and the fluid communication between the first fluid connection and the second fluid connection is reducible by a motion of the sealing element coupled with the control piston, and the fluid communication between the first fluid connection and the second fluid connection, at the predetermined maximum pressure value at the second fluid connection, is completely interrupted by a stop position of the sealing region of the sealing element in the seal seat of the valve body, and the spring force of the adjusting spring moves the control piston back out of the stop position toward the outset position when an actual pressure at the second fluid connection drops below the maximum pressure value.

22. The control valve as defined by claim 14, wherein a pressure building up at the first fluid connection moves the control piston, counter to the spring force of the adjusting spring, in the direction of the pressure-relieved connection, and the fluid communication between the first fluid connection and the second fluid connection is reducible by a motion of the sealing element coupled with the control piston, and the fluid communication between the first fluid connection and the second fluid connection, at the predetermined maximum pressure value at the second fluid connection, is completely interrupted by a stop position of the sealing region of the sealing element in the seal seat of the valve body, and the spring force of the adjusting spring moves the control piston back out of the stop position toward the outset position when an actual pressure at the second fluid connection drops below the maximum pressure value.

23. The control valve as defined by claim 16, wherein a pressure building up at the first fluid connection moves the control piston, counter to the spring force of the adjusting spring, in the direction of the pressure-relieved connection, and the fluid communication between the first fluid connection and the second fluid connection is reducible by a motion of the sealing element coupled with the control piston, and the fluid communication between the first fluid connection and the second fluid connection, at the predetermined maximum pressure value at the second fluid connection, is completely interrupted by a stop position of the sealing region of the sealing element in the seal seat of the valve body, and the spring force of the adjusting spring moves the control piston back out of the stop position toward the outset position when an actual pressure at the second fluid connection drops below the maximum pressure value.

24. The control valve as defined by claim 11, wherein the first fluid connection is embodied as a master cylinder connection, which is coupled with a master cylinder in the vehicle brake system, and the second fluid connection is embodied as a pipe connection, which is coupled with a return pump.

25. The control valve as defined by claim 23, wherein the first fluid connection is embodied as a master cylinder connection, which is coupled with a master cylinder in the vehicle brake system, and the second fluid connection is embodied as a pipe connection, which is coupled with a return pump.

26. A vehicle brake system having a master cylinder, a fluid control unit, and at least one wheel brake, in which the fluid control unit, for modulating the brake pressure of the at least one wheel brake in at least one brake circuit, includes one switchover, one intake valve, and one return pump each, wherein the intake valve is embodied as a control valve as defined by claim 11, which is looped into a respective section line between a corresponding return pump and the master cylinder.

27. A vehicle brake system having a master cylinder, a fluid control unit, and at least one wheel brake, in which the fluid control unit, for modulating the brake pressure of the at least one wheel brake in at least one brake circuit, includes one switchover, one intake valve, and one return pump each, wherein the intake valve is embodied as a control valve as defined by claim 25, which is looped into a respective section line between a corresponding return pump and the master cylinder.

28. A brake system as defined by claim 26, wherein the control piston of the control valve, during a suction mode of the return pump, remains in the outset position, and during a partly active state of the brake system the control piston is subjected by the first fluid connection which is embodied as a master cylinder connection to a pressure which moves the control piston in the direction of the pressure-relieved connection, counter to the spring force of the adjusting spring, and upon attainment of the maximum pressure value and a corresponding stop position, in which the sealing region of the sealing element, coupled with the control piston, provides sealing in the seal seat of the valve body, the piston completely interrupts the fluid communication between the master cylinder connection and the second fluid connection which is embodied as a pipe connection, and the spring force of the adjusting spring moves the control piston out of the stop position in the direction of the outset position when an actual pressure at the pipe connection drops below the maximum pressure value.

29. A brake system as defined by claim 27, wherein the control piston of the control valve, during a suction mode of the return pump, remains in the outset position, and during a partly active state of the brake system the control piston is subjected by the first fluid connection which is embodied as a master cylinder connection to a pressure which moves the control piston in the direction of the pressure-relieved connection, counter to the spring force of the adjusting spring, and upon attainment of the maximum pressure value and a corresponding stop position, in which the sealing region of the sealing element, coupled with the control piston, provides sealing in the seal seat of the valve body, the piston completely interrupts the fluid communication between the master cylinder connection and the second fluid connection which is embodied as a pipe connection, and the spring force of the adjusting spring moves the control piston out of the stop position in the direction of the outset position when an actual pressure at the pipe connection drops below the maximum pressure value.

30. The brake system as defined by claim 28, wherein the control piston of the control valve, in the pressureless state, remains in the outset position, and during an ABS intervention is acted upon by the master cylinder connection with a pressure which moves the control piston, counter to the spring force of the adjusting spring, towards the pressure-relieved connection, and upon attainment of the maximum pressure value and the corresponding stop position, in which the sealing region of the sealing element, coupled with the control piston, provides sealing in the seal seat of the valve body, the control piston completely interrupts the fluid communication between the master cylinder connection and the pipe connection, and in this state the fluid control unit performs an ABS control operation.
